(19) United States
(12) Patent Application Publication
(10) Pub. No.: US 2024/0123883 A1
(43) Pub. Date: Apr. 18, 2024

(54) RECONFIGURABLE VEHICLE SEAT AND A VEHICLE HAVING A RECONFIGURABLE VEHICLE SEAT

(71) Applicant: GM Global Technology Operations LLC, Detroit, MI (US)

(72) Inventors: Sreejit Narayan Sivasankaran, Troy, MI (US); Sarah Glissman, Lake Orion, MI (US); Joel S. Hooton, Chesterfield, MI (US); Joel Andrew Benkelman, St. Clair Shores, MI (US); Raihan Haque, Warren, MI (US)

(21) Appl. No.: 17/968,092

(22) Filed: Oct. 18, 2022

(51) Int. Cl. B60N 2/70; B60N 2/72

(52) U.S. Cl. CPC B60N 2/7005; B60N 2/72

(57) ABSTRACT

A reconfigurable vehicle seat includes a seat base having a center cushion having a first lateral side and a second lateral side that is opposite the first lateral side. A first side bolster including a first lateral side section is detachably connected to the first lateral side, and a second side bolster including a second lateral side section is detachably connected to the second lateral side.

### INTRODUCTION

The subject disclosure relates to the art of vehicles and, more particularly, to a reconfigurable seat for a vehicle.

Vehicles includes a number of seats that accommodate a driver and/or passengers. The seat typically includes a seat base and a seat back. The seat back often times supports a headrest. The seat base typically includes a center cushion flanked by first and second side bolsters that are formed as a single member and then upholstered. Over time, both the center cushion and the side bolsters wear due to repeated contact with clothing.

Typically, the side bolster nearest a vehicle door gets more wear than the opposite side bolster due to users getting into and out from the vehicle. Replacing vehicle cushions is a time consuming and costly process. Accordingly, it is desirable to provide a system for readily replacing vehicle cushions to replace worn upholstery as well as to allow for more upholstery options.

### SUMMARY

A reconfigurable vehicle seat, in accordance with a non-limiting example, includes a seat base having a center cushion including a first lateral side and a second lateral side that is opposite the first lateral side. A first side bolster including a first lateral side section is detachably connected to the first lateral side, and a second side bolster including a second lateral side section is detachably connected to the second lateral side.

In addition to one or more of the features described herein the first lateral side of the center cushion includes a first connector element and the first lateral side section of the first side bolster includes a second connector element that engages with the first connector element to secure the first side bolster to the center cushion.

In addition to one or more of the features described herein the first connector element comprises a hook connector and the second connector element comprises a loop connector such that the first side bolster is detachably connected with the center cushion through a hook and loop connection.

In addition to one or more of the features described herein the first connector element comprises first tooth portion and the second connector element comprises a second tooth portion such that the first side bolster is detachably connected with the center cushion through a zipper connection.

In addition to one or more of the features described herein the first connector element comprises a recess formed in first lateral side of the center cushion and the second connector element comprises a projection that extends outwardly from the first lateral side section, the projection being received by the recess to join the first side bolster to the center cushion.

In addition to one or more of the features described herein the center cushion includes a forward surface and the first side bolster includes a forward surface section, the recess extending along the first lateral side from the forward surface and the projection extending along the first lateral side section from the forward surface section.

In addition to one or more of the features described herein the recess comprises a reinforced slot, the projection being insertable into the reinforced slot.

In addition to one or more of the features described herein the reconfigurable seat includes a seat pan, the center cushion and the first side bolster being connected to the seat pan and a seat back connected to the seat base.

In addition to one or more of the features described herein the first side bolster includes an alignment member that extends into the seat pan.

In addition to one or more of the features described herein an articulating transfer board is detachably connected to the first lateral side of the center cushion.

A vehicle, in accordance with another non-limiting example, includes a body defining a passenger compartment and a reconfigurable vehicle seat arranged in the passenger compartment. The reconfigurable vehicle seat includes a seat base having a center cushion including a first lateral side and a second lateral side that is opposite the first lateral side. A first side bolster including a first lateral side section is detachably connected to the first lateral side, and a second side bolster including a second lateral side section is detachably connected to the second lateral side.

In addition to one or more of the features described herein the first lateral side of the center cushion includes a first connector element and the first lateral side section of the first side bolster includes a second connector element that engages with the first connector element to secure the first side bolster to the center cushion.

In addition to one or more of the features described herein the first connector element comprises a hook connector and the second connector element comprises a loop connector such that the first side bolster is detachably connected with the center cushion through a hook and loop connection.

In addition to one or more of the features described herein the first connector element comprises first tooth portion and the second connector element comprises a second tooth portion such that the first side bolster is detachably connected with the center cushion through a zipper connection.

In addition to one or more of the features described herein the first connector element comprises a recess formed in first lateral side of the center cushion and the second connector element comprises a projection that extends outwardly from the first lateral side section, the projection being received by the recess to join the first side bolster to the center cushion.

In addition to one or more of the features described herein the center cushion includes a forward surface and the first side bolster includes a forward surface section, the recess extending along the first lateral side from the forward surface and the projection extending along the first lateral side section from the forward surface section.

In addition to one or more of the features described herein the first lateral side section includes a reinforced slot, the projection being insertable into the reinforced slot.

In addition to one or more of the features described herein the vehicle includes a seat pan, the center cushion and the first side bolster being connected to the seat pan and a seat back connected to the seat base.

In addition to one or more of the features described herein the first side bolster includes an alignment member that extends into the seat pan.

In addition to one or more of the features described herein an articulating transfer board detachably connected to the first lateral side of the center cushion.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of a vehicle including a reconfigurable vehicle seat, in accordance with a non-limiting example;

FIG. 2 is a partial cross-sectional front view of a reconfigurable vehicle seat, in accordance with a non-limiting example;

FIG. 3 is a disassembled view of seat base cushions of the reconfigurable vehicle seat of FIG. 2, in accordance with a non-limiting example;

FIG. 4 is a partial perspective view of the reconfigurable vehicle seat of FIG. 3, in accordance with a non-limiting example;

FIG. 5 is a partial perspective view of a reconfigurable vehicle seat, in accordance with a non-limiting example;

FIG. 6 is a front cross-sectional plan view of a seat base cushion assembly of the reconfigurable vehicle seat of FIG. 5, in accordance with another non-limiting example;

FIG. 7 is a partial perspective view of a reconfigurable vehicle seat, in accordance with a non-limiting example;

FIG. 8 is a front cross-sectional plan view of a seat base cushion assembly of the reconfigurable vehicle seat of FIG. 7, in accordance with another non-limiting example;

FIG. 9 is a perspective partial front view of a reconfigurable vehicle seat including an articulating transfer board (ATB) in a non-deployed configuration, in accordance with a non-limiting example; and

FIG. 10 is a perspective partial front view of a reconfigurable vehicle seat including the ATB of FIG. 9 in a deployed configuration, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

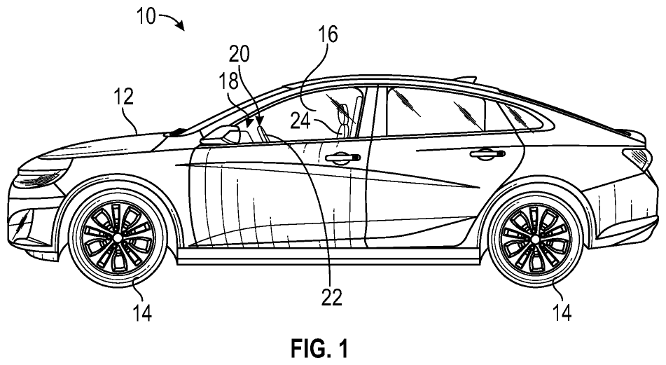

A vehicle, in accordance with a non-limiting example, is indicated generally at 10 in FIG. 1. Vehicle 10 includes a body 12 supported by a plurality of wheels, two of which are indicated at 14. In the non-limiting example shown, two of the plurality of wheels 14 are steerable wheels. That is, changing a position of the two front wheels of the plurality of wheels 14 relative to body 12 will cause vehicle 10 to change direction. Body 12 defines a passenger compartment 16 within which is arranged a dashboard 18 and a steering system 20 including a steering wheel 22. Of course, it should be understood vehicle 10 may be an autonomous vehicle and thus may not include a steering wheel.

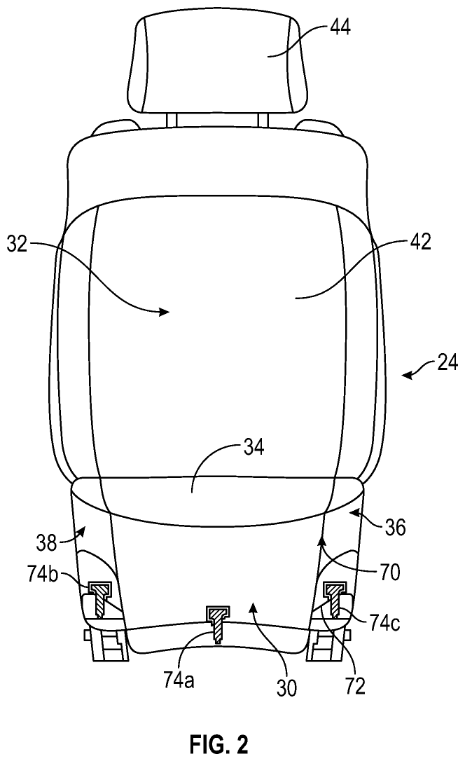

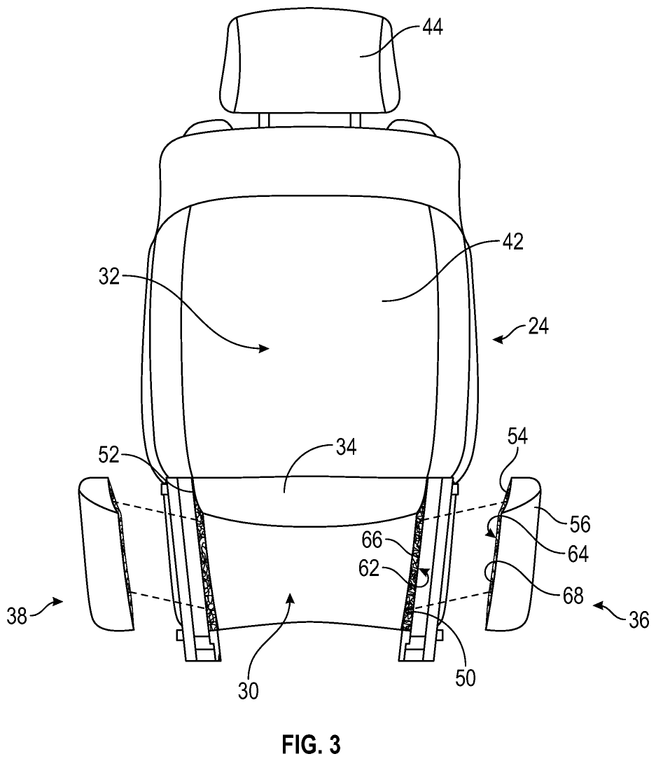

A seat 24 is arranged aft of steering wheel 22. Referring to FIGS. 2 and 3, seat 24 includes a seat base 30 and a seat back 32. In a non-limiting example, seat back 32 is pivotally mounted relative to seat base 30. Seat base 30 includes a center cushion 34 flanked by a first side bolster 36 and a second side bolster 38. Seat back 32 includes a support surface 42 and a headrest 44. Center cushion 34 of seat base 30 includes a first lateral side 50 (FIG. 3) and a second lateral side 52. Second lateral side 52 is on an opposite side (not separately labeled) of center cushion 34 relative to first lateral side 50.

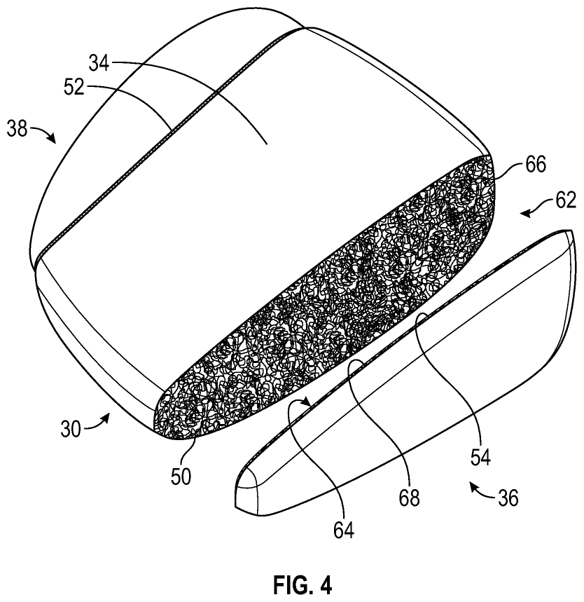

In a non-limiting example depicted in FIGS. 3 and 4, first side bolster 36 includes a first lateral side section 54 which, as will be discussed more fully herein, is detachably connected to first lateral side 50 of center cushion 34. First side bolster also includes a second lateral side section 56. In a non-limiting example, a first connector element 62 is arranged on first lateral side 50 and a second connector element 64 is arranged on first lateral side section 54. At this point, it should be understood that second lateral side bolster 38 includes similar structure and is detachably mounted to second lateral side 52 of center cushion 34. In a non-limiting example, first connector element 62 takes the form of a hook connector 66 and second connector element 64 takes the form of a loop connector 68. When brought together, a hook and loop connection 70 (FIG. 2) is established to connect first side bolster 36 to first lateral side 50 of center cushion 34. It should be understood that the positions of hook connector 66 and loop connector 68 may be reversed.

In a non-limiting example depicted in FIG. 2, seat 24 includes a seat pan 72 that provides structural support for seat base 30 as well as establishes an interface with body 12. That is, seat pan 72 supports center cushion 34 as well as first side bolster 36 and second side bolster 38. Alignment members, three of which are shown at 74a, 74b, and 74c in FIG. 2, pass from corresponding ones of center cushion 34, first side bolster 36 and second side bolster 38 to establish a selected alignment between seat base 30 and seat pan 72. At this point, it should be understood that the number and location of alignment members may vary.

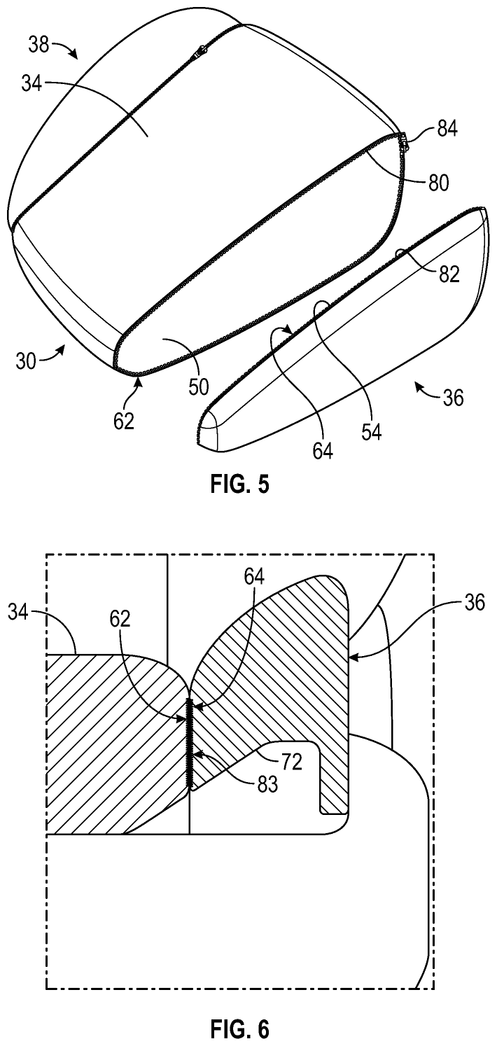

Referring to FIGS. 5 and 6, first connector element 62 is takes the form of a first tooth portion 80 and second connector element 64 takes the form of a second tooth portion 82 that when brought together form a chain or zipper connection 83 (FIG. 6). That is, a zipper slide 84 (FIG. 5) joins first tooth portion 80 and second tooth portion 82 to form chain 83 that detachably joins first lateral side section 54 of first side bolster 36 with first lateral side 50 of center cushion 34.

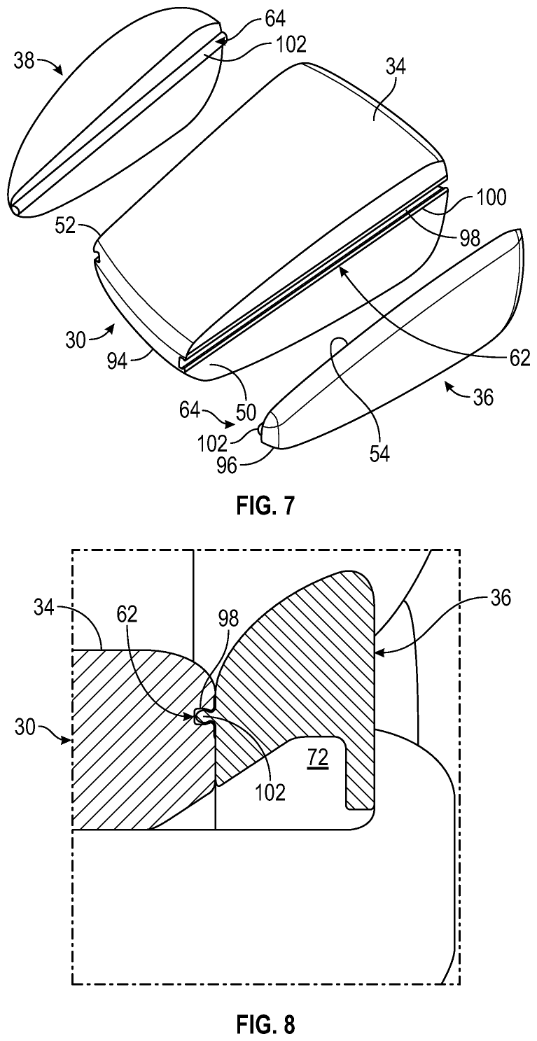

Referring to FIGS. 7 and 8 center cushion 34 includes a forward surface 94 and first side bolster 36 includes a forward surface section 96. In a non-limiting example, first connector element 62 takes the form of a recess 98 formed in first lateral side 50 of center cushion 34. Recess 98 takes the form of a reinforced slot 100 having a partially circular cross-section that extends within first lateral side 50 from forward surface 94.

Reinforced slot 100 may be reinforced with metal, plastic, or other wear resistant material that resists deformation in order to retain second connector element 64 on first side bolster 36. Second connector element 64 is shown in the form of a projection 102 that has a cross-section which substantially matches the partially circular cross-section of recess 98. Projection 102 may take the form of a single projection that extends along and projects outwardly from first lateral side section 54 from forward surface section 96 and is received in recess 98. Projection 102 may also take the form of multiple projections that are inserted into recess 98 to join first side bolster 36 with center cushion 34.

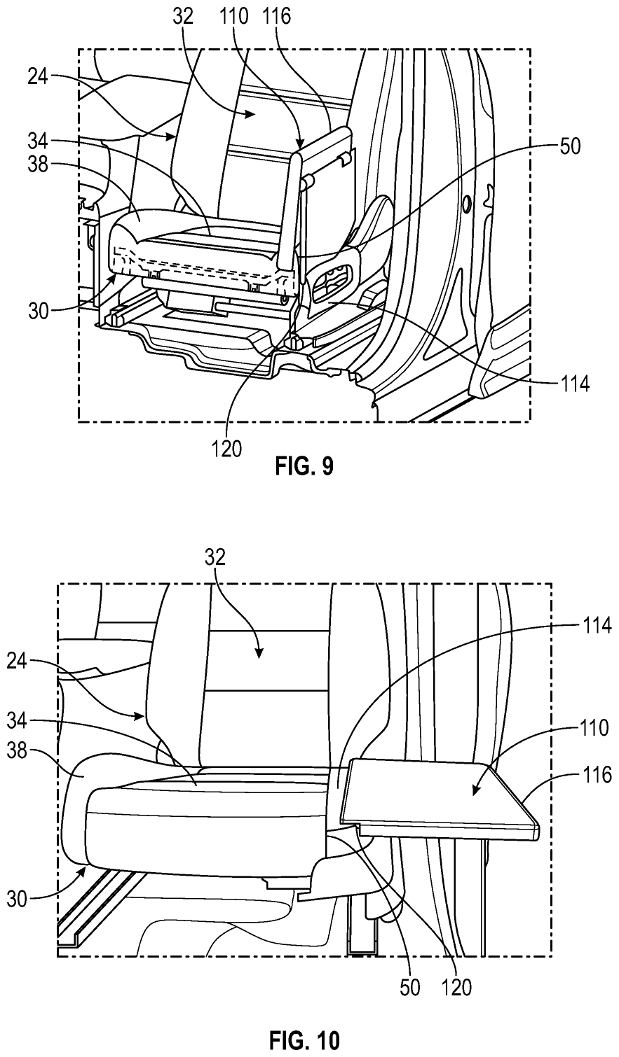

Referring to FIGS. 9 and 10, first side bolster 36 may be replaced by an articulating transfer board (ATB) 110 that may facilitate entry into passenger compartment 16 for a passenger or driver in a wheelchair. ATB 110 includes a first member 114 that is connected to first lateral side 50 and a second member 116 that is cantilevered from first member 114 and seat base 30. In a non-limiting example, a hinge 120 connects first member 114 and second member 116 so that ATB 110 may transition from a stowed configuration (FIG. 9) to a deployed configuration (FIG. 10). Hinge 120 is connected to a seat pan such as shown at 72 in FIG. 2 through first member 114 to provide added structural support for ATB 110. When deployed, a driver or passenger may easily transition from a wheel chair into the passenger compartment, fold ATB 110 and close a vehicle door (not separately labeled).

At this point, it should be understood that the reconfigurable vehicle seat in accordance with the present disclosure allows a user to change seat characteristics, replace worn seat components, mix and match colors, fabrics and the like, and/or add functionality to enhance an overall appearance and utility of the vehicle.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A reconfigurable vehicle seat comprising:
a seat base comprising:
a center cushion having a first lateral side and a second lateral side that is opposite the first lateral side;
a first side bolster including a first lateral side section detachably connected to the first lateral side; and
a second side bolster including a second lateral side section detachably connected to the second lateral side.

2. The reconfigurable vehicle seat according to claim 1, wherein the first lateral side of the center cushion includes a first connector element and the first lateral side section of the first side bolster includes a second connector element that engages with the first connector element to secure the first side bolster to the center cushion.

3. The reconfigurable vehicle seat according to claim 2, wherein the first connector element comprises a hook connector and the second connector element comprises a loop connector such that the first side bolster is detachably connected with the center cushion through a hook and loop connection.

4. The reconfigurable vehicle seat according to claim 2, wherein the first connector element comprises first tooth portion and the second connector element comprises a second tooth portion such that the first side bolster is detachably connected with the center cushion through a zipper connection.

5. The reconfigurable vehicle seat according to claim 2, wherein the first connector element comprises a recess formed in first lateral side of the center cushion and the second connector element comprises a projection that extends outwardly from the first lateral side section, the projection being received by the recess to join the first side bolster to the center cushion.

6. The reconfigurable vehicle seat according to claim 5, wherein the center cushion includes a forward surface and the first side bolster includes a forward surface section, the recess extending along the first lateral side from the forward surface and the projection extending along the first lateral side section from the forward surface section.

7. The reconfigurable vehicle seat according to claim 5, wherein the recess comprises a reinforced slot, the projection being insertable into the reinforced slot.

8. The reconfigurable vehicle seat according to claim 2, further comprising a seat pan, the center cushion and the first side bolster being connected to the seat pan and a seat back connected to the seat base.

9. The reconfigurable vehicle seat according to claim 8, wherein the first side bolster includes an alignment member that extends into the seat pan.

10. The reconfigurable vehicle seat according to claim 1, further comprising an articulating transfer board detachably connected to the first lateral side of the center cushion.

11. A vehicle comprising:
a body defining a passenger compartment; and
a reconfigurable vehicle seat arranged in the passenger compartment, the reconfigurable vehicle seat comprising:
a seat base comprising:
a center cushion having a first lateral side and a second lateral side that is opposite the first lateral side;
a first side bolster including a first lateral side section detachably connected to the first lateral side; and
a second side bolster including a second lateral side section detachably connected to the second lateral side.

12. The vehicle according to claim 11, wherein the first lateral side of the center cushion includes a first connector element and the first lateral side section of the first side bolster includes a second connector element that engages with the first connector element to secure the first side bolster to the center cushion.

13. The vehicle according to claim 12, wherein the first connector element comprises a hook connector and the second connector element comprises a loop connector such that the first side bolster is detachably connected with the center cushion through a hook and loop connection.

14. The vehicle according to claim 12, wherein the first connector element comprises first tooth portion and the second connector element comprises a second tooth portion such that the first side bolster is detachably connected with the center cushion through a zipper connection.

15. The vehicle according to claim 12, wherein the first connector element comprises a recess formed in first lateral side of the center cushion and the second connector element comprises a projection that extends outwardly from the first lateral side section, the projection being received by the recess to join the first side bolster to the center cushion.

16. The vehicle according to claim 15, wherein the center cushion includes a forward surface and the first side bolster includes a forward surface section, the recess extending along the first lateral side from the forward surface and the projection extending along the first lateral side section from the forward surface section.

17. The vehicle according to claim 15, wherein the first lateral side section includes a reinforced slot, the projection being insertable into the reinforced slot.

18. The vehicle according to claim 12, further comprising a seat pan, the center cushion and the first side bolster being connected to the seat pan and a seat back connected to the seat base.

19. The vehicle according to claim 18, wherein the first side bolster includes an alignment member that extends into the seat pan.

20. The vehicle according to claim 11, further comprising an articulating transfer board detachably connected to the first lateral side of the center cushion.
